(19) United States
(12) Patent Application Publication
(10) Pub. No.: US 2019/0231116 A1
(43) Pub. Date: Aug. 1, 2019

(54) BEVERAGE DISPENSER TRAY

(71) Applicant: Ada Brown, Grayson, GA (US)

(72) Inventor: Ada Brown, Grayson, GA (US)

(21) Appl. No.: 15/885,835

(22) Filed: Feb. 1, 2018

(51) Int. Cl. A47J 31/44; B67D 1/08

(52) U.S. Cl. CPC A47J 31/4428; B67D 1/0891

(57) ABSTRACT

A beverage dispenser tray including a catch surface, a base disposed at a center portion of the catch surface, and a plurality of walls surrounding and enclosing the catch surface.

### BACKGROUND OF THE INVENTION

### 1. Field of the Invention

The present general inventive concept relates generally to a beverage dispenser tray, and specifically, to a beverage dispenser tray to place under a beverage dispenser.

### 2. Description of the Related Art

Conventional beverage dispensers usually include a fillable plastic or glass container with a spigot/spout at a base portion thereof, which dispenses liquid stored in the container. These conventional beverage dispensers are a mainstay in homes, as they are often used for parties, dinners, and/or social gatherings; however, they are prone to spillage which can damage the surface it is placed on and can be a time consuming task to clean. More specifically, during the process of filing a cup, users frequently have small spills near and around the spout and beverage dispenser.

Moreover, although present beverage dispensers on the market are available with taps, they can produce a large amount of waste when liquid drips out of the taps, causing cleaning of a floor or carpet to be an extremely difficult and costly process.

Therefore, there is a need for a device that protects surfaces from liquids dripping and/or pouring from beverage dispensers.

### SUMMARY

The present general inventive concept provides a beverage dispenser tray.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a beverage dispenser tray including a catch surface, a base disposed at a center portion of the catch surface, and a plurality of walls surrounding and enclosing the catch surface.

The catch surface may be beveled with respect to the base.

The base may be elevated with respect to the catch surface.

The plurality of walls may be beveled to slope downward toward the catch surface.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1 illustrates a beverage dispenser tray, according to an exemplary embodiment of the present general inventive concept; and

FIG. 2 illustrates a beverage dispenser tray, according to another exemplary embodiment of the present general inventive concept.

### DETAILED DESCRIPTION OF THE INVENTION

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

The present general inventive concept relates to a beverage dispensing tray that is placed under a beverage dispenser to secure or to provide a spillage area for a beverage dispenser. Typically, a beverage dispenser has a spout that allows a user to obtain fluids from the beverage dispenser. Many times during filling of cups or other vessels, a user has spillage near and around the beverage dispenser. The present invention includes a tray that has a base component at the center of the tray. Surrounding the tray are beveled walls that surround a catch surface within the beverage tray. During use, a user will place a beverage dispenser in the center of the tray, therefore allowing the catch surface to catch any spillage from the beverage dispenser.

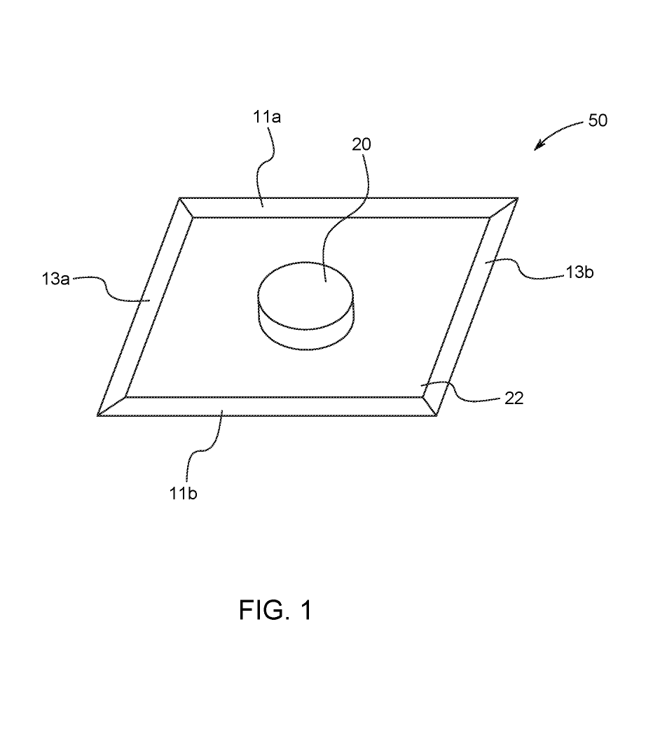

FIG. 1 illustrates a beverage dispenser tray 50, according to an exemplary embodiment of the present general inventive concept

Referring to FIG. 1, the beverage dispenser tray 50 may include a base 20.

The base 20 may be circular in order to receive a cylindrical-type beverage dispenser thereupon.

The base 20 may be elevated with respect to a catch surface 22, which surrounds the base 20.

The catch surface 22 may catches drops or spillage related to liquid stored within the beverage dispenser. In other words, if a user attempts to dispense liquid stored within the beverage dispenser into a cup and removes the cup before the liquid ceases flowing, the catch surface 22 may catch the excess liquid in order to prevent spillage outside the beverage dispenser tray 50.

Disposed at an outer perimeter of the tray 50 are walls 11a, 11b and walls 13a, 13b, provided on opposing sides of the tray 50.

The walls 11a, 11b, 13a, and 13b surround the catch surface 22, and prevent the excess liquid from overflowing out from the beverage dispenser tray 50.

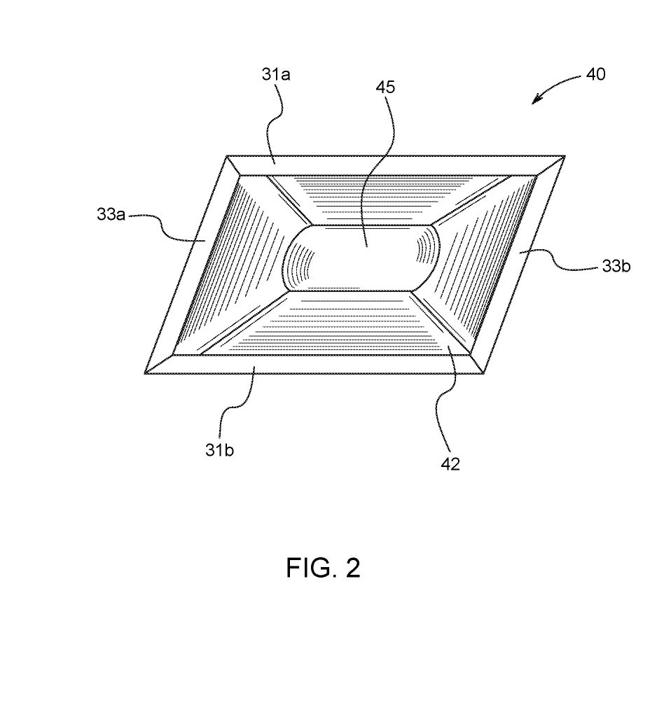

FIG. 2 illustrates a beverage dispenser tray 40, according to another exemplary embodiment of the present general inventive concept.

Referring to FIG. 2, an oval-shaped base 45 is illustrated within the beverage dispenser tray 40. The base 45 may receive a beverage dispenser upon a top surface thereof.

The base 45 includes a stand within the tray 50. More specifically, the base 45 may be surrounded by catch surface 42, which is illustrated in FIG. 2 as four beveled sections that slope downward from the base 45 toward beveled walls 31a, 31b, 33a, and 33b. In other words, these four sections of the catch surface 42 make up the entire catch surface 42 for the tray 40 that causes liquid dispensed from the beverage dispenser to be caught and accumulated at crevices between the catch surface 42 and the beveled walls 31a, 31b, 33a, and 33b.

In other words, the beveled walls 31a, 31b, 33a, and 33b surround the catch surface 42, and prevent the excess liquid from overflowing out from the beverage dispenser tray 40.

Similarly as the beverage dispenser tray 50 of FIG. 1, the beverage dispenser tray 40 may include the base 45 to be elevated with respect to the catch surface 42.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A beverage dispenser tray to hold a beverage dispenser thereupon, the beverage dispenser tray comprising:
a base disposed at a center portion of the beverage dispenser tray to hold the beverage dispenser thereupon;
a catch surface to surround the base such that the catch surface is divided into a plurality of separate and distinct sections each having their own sloping directions, the plurality of sections comprising:
a first beveled section to slope in a first direction with respect to the base,
a second beveled section disposed adjacent to the first beveled section to slope in a second direction with respect to the base,
a third beveled section disposed adjacent to the second beveled section to slope in a third direction with respect to the base, and
a fourth beveled section disposed adjacent to the third beveled section to slope in a fourth direction with respect to the base, such that the catch surface receives liquid dripping from a spout of the beverage dispenser, and such that a number of the plurality of separate and distinct sections does not exceed twelve;
a plurality of walls surrounding and enclosing the catch surface, such that each of the plurality of walls corresponds to at least one of the plurality of separate and distinct sections.

2. (canceled)

3. The beverage dispenser tray of claim 1, wherein the base is elevated with respect to the catch surface.

4. The beverage dispenser tray of claim 1, wherein the plurality of walls are beveled to slope downward toward the catch surface.
